(19) United States
(12) Patent Application Publication
(10) Pub. No.: US 2015/0190908 A1
(43) Pub. Date: Jul. 9, 2015

(54) Rotational Impact Tool

(71) Applicant: Hitachi Koki Co., Ltd., Minato-ku, Tokyo (JP)

(72) Inventors: Naoki Tadokoro, Hitachinaka (JP); Hironori Sakai, Hitachinaka (JP)

(73) Assignee: Hitachi Koki Co.,Ltd., Tokyo (JP)

(21) Appl. No.: 14/399,662

(22) PCT Filed: Jun. 3, 2013
(86) PCT No.: PCT/JP2013/003473

§ 371 Date: Nov. 7, 2014

(30) Foreign Application Priority Data
Sep. 28, 2012 (JP) 2012-216117

(51) Int. Cl. B25B 21/02

(52) U.S. Cl. CPC B25B 21/02

(57) ABSTRACT

A rotational impact tool including: a motor; a spindle; a hammer; a first resilient member; and an anvil. The motor generates a drive force. The spindle rotates in a rotating direction upon transmission of the drive force from the motor. The spindle has an axis extending in an axial direction that includes a first direction and a second direction opposite to the first direction. The hammer moves in the rotational direction and in the axial direction relative to the spindle to generate a rotational impact force. The first resilient member urges the hammer in the first direction. The anvil transmits the rotational impact force to an end bit. The rotational impact tool further includes a second resilient member. The second resilient member is disposed at a position radially outward of the first resilient member and is configured to abut the hammer when the hammer moves in the second direction.

### TECHNICAL FIELD

The invention relates to a rotational impact tool for fastening a screw, a bolt, a nut and the like, to a workpiece.

### BACKGROUND ART

An impact wrench as a rotational impact tool for fastening a screw, a bolt, a nut and the like to a workpiece is disclosed in Japanese Patent Application Publication No. 2012-66344. The rotational impact tool mainly includes a large-sized impact mechanism having a hammer and an anvil, a deceleration mechanism, and a spindle. The hammer is urged forward by a spring disposed between the deceleration mechanism and the spindle. When rotational resistance relative to the anvil becomes greater after the screw, for example, is seated, rotation of the anvil is restrained. Then, the hammer moves backward against the urging force by the spring to circumvent a projecting portion of the anvil and is accelerated to exert an impact on the anvil. By repeating this impact operation, the rotational impact force is continuously or intermittently transmitted to an end bit to fasten the screw to the workpiece.

Another impact wrench is disclosed in Japanese Patent Application Publication No. 2002-46078. The impact wrench includes a spindle, a hammer, and an anvil. A steel ball is held by a cam groove formed in the spindle and a cam groove formed in the hammer, so that rotation of the spindle is transmitted to the hammer. When fastening a hard member, such as a bolt and a nut, to a workpiece, a large impact reaction force unavoidably occurs between the anvil and the hammer for hitting the anvil, thereby moving the hammer rearward to a large extent. At this time, the steel ball may collide against a cam end of the cam groove formed in the spindle. Collision of the steel ball against the cam end generates noises and vibrations due to its immense impact. In order to restrain occurrence of noises and vibrations, a rear end face of the hammer is abuttable on a resilient member.

### CITATION LIST

### Patent Literature

PTL 1: Japanese Patent Application Publication No. 2012-66344
PTL 2: Japanese Patent Application Publication No. 2002-46078

### DISCLOSURE OF INVENTION

### Solution to Problem

However, since the resilient member is disposed between the spindle and the spring, it is difficult to provide such a resilient member in an impact wrench, in particular, a large-sized impact wrench, in which a gap between the spindle and the spring is small. Providing such a resilient member in the impact wrench restricts the size of the outer diameter of the spindle, which causes difficulty in transmitting the rotational impact force to the end bit.

In view of the foregoing, an object of the invention is to provide a rotational impact tool capable of preventing noises and vibrations during impact operations and prolonging a service life of a cam mechanism provided in the impact tool.

In order to attain above and other object, the present invention provides a rotational impact tool including: a motor; a spindle; a hammer; a first resilient member; and an anvil. The motor is configured to generate a rotational drive force. The spindle is configured to rotate in a rotating direction upon transmission of the rotational drive force from the motor. The spindle has an axis extending in an axial direction. The axial direction includes a first direction and a second direction opposite to the first direction. The hammer is configured to move in the rotational direction and in the axial direction relative to the spindle to generate a rotational impact force. The first resilient member is configured to urge the hammer in the first direction. The anvil is configured to transmit the rotational impact force from the hammer to an end bit. The rotational impact tool is characterized by: a second resilient member. The second resilient member is disposed at a position radially outward of the first resilient member. The second resilient member is configured to abut the hammer when the hammer moves in the second direction.

This configuration allows the spindle to have a large outer diameter, thereby reducing an impact exerted on a cam mechanism provided in the rotational impact tool caused by movement of the hammer in the second direction. Accordingly, the service life of the rotational impact tool can be prolonged.

It is preferable that the second resilient member comprises a compression coil spring.

With this configuration, the impacting force caused by the movement of the hammer in the second direction can be relatively gently absorbed by the second resilient member, and noises and vibrations can be reliably reduced.

It is preferable that the rotational impact tool further comprises a guide portion configured to guide the axial movement of the hammer. The guide portion is configured to be supported to the spindle. The guide portion includes a cylindrical portion surrounding the first resilient member and a projecting portion projecting radially outward from the cylindrical portion. The projecting portion is configured to restrict the second resilient member from moving in the axial direction.

With this configuration, the second resilient member can be subjected to positioning at a fixed position, thereby preventing the second resilient member from displacing from the guide portion and also from being damaged.

It is preferable that the hammer includes an end portion formed with a recess. The recess is configured to prevent interference between the end portion and the projecting portion when the hammer moves in the second direction.

With this configuration, the end portion is abuttable on the second resilient member without interference from the projecting portion. Accordingly, the impacting force caused by the movement of the hammer in the second direction can be relatively gently absorbed by the second resilient member, and mitigation of noises and vibrations can be reliably realized.

It is preferable that the cylindrical portion has an outer circumference defining a circumferential direction and that the projecting portion includes a plurality of projections formed intermittently on the outer circumference of the cylindrical portion along the circumferential direction.

It is preferable that the cylindrical portion is disposed between the first resilient member and the second resilient member.

### Advantageous Effects of Invention

The present invention described above can provide a rotational impact tool that can restrain noises and vibrations caused by cam end collision during impact operations and that can prolong a service life of a cam mechanism provided in the rotational impact tool.

### BRIEF DESCRIPTION OF DRAWINGS

FIG. 1 is a cross-sectional view of a rotational impact tool according to one embodiment of the present invention;

FIG. 2A is a cross-sectional view of an essential part of the rotational impact tool according to the embodiment;

FIG. 2B is a schematic view of a guide portion and a first resilient member provided in the rotational impact tool according to the embodiment;

FIG. 3 is a partial cross-sectional view of the essential part, showing a state prior to starting a backward movement of a hammer provided in the rotational impact tool according to the embodiment;

FIG. 4 is a partial cross-sectional view of the essential part, showing a state subsequent to the state shown in FIG. 3;

FIG. 5 is a partial cross-sectional view of the essential part, showing a state subsequent to the state shown in FIG. 4;

FIG. 6 is a partial cross-sectional view of the essential part, showing a state subsequent to the state shown in FIG. 5;

FIG. 7 is an exploded perspective view of a hammer, the first resilient member, the guide portion, a second resilient member, and a spindle provided in the rotational impact tool according to the embodiment; and

FIG. 8 is a perspective view of the guide portion provided in the rotational impact tool according to the embodiment.

### BEST MODE FOR CARRYING OUT THE INVENTION

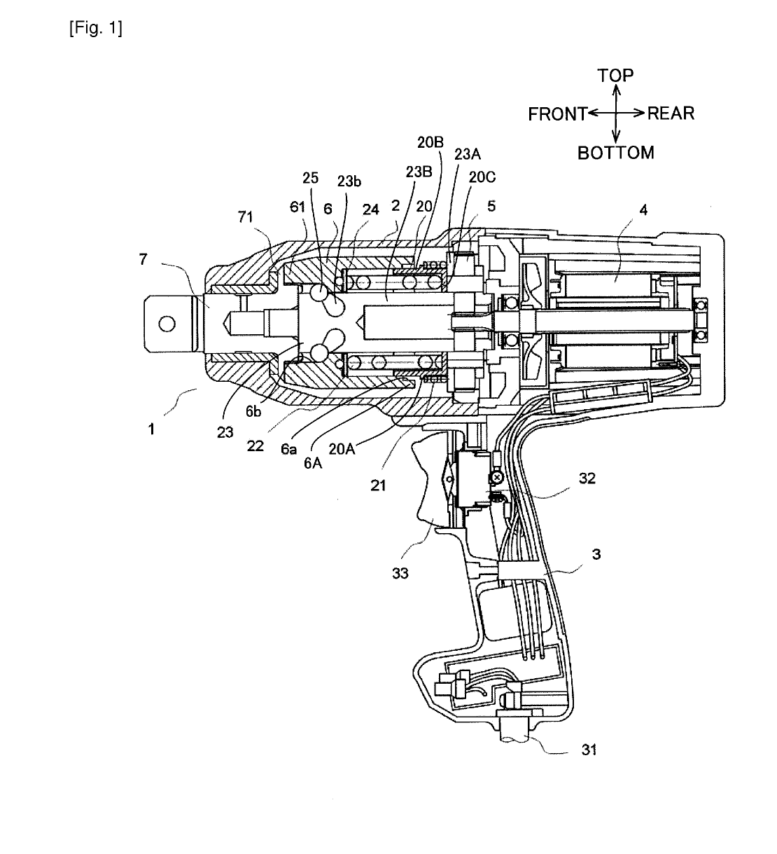

An impact wrench as a rotational impact tool according to one embodiment of the present invention will be described while referring to FIGS. 1 through 8 wherein like parts and components are designated by the same reference numerals to avoid duplicating description. Note that the rotational impact tool is not limited to the impact wrench, in so far as the tool includes a configuration for preventing the cam end collision.

The impact wrench 1 shown in FIG. 1 is a tool for fastening a screw, a bolt, a nut, and the like. As shown in FIG. 1, the impact wrench 1 mainly includes a main body housing 2, a handle housing 3, a motor 4, a gear mechanism 5, a hammer 6, and an anvil 7. The hammer 6 and the anvil 7 constitute an impact mechanism.

In the following description, the left side of the impact wrench 1 in FIG. 1 will be defined as the front side, while the right side in FIG. 1 will be defined as the rear side. In other words, the side where the anvil 7 is provided will be referred to as the front side, and the side where the motor 4 is provided will be referred to as the rear side. The top and bottom sides of the impact wrench 1 in FIG. 1 will be defined as the top and bottom sides, respectively.

The main body housing 2 and the handle housing 3 are integrally formed of resin. The main body housing 2 is formed in a generally cylindrical shape. The motor 4, the gear mechanism 5, the hammer 6, and the anvil 7 are provided at the main body housing 2 in this order from rear to front.

Further, the impact wrench 1 includes a spindle 23, a guide portion 20, a first resilient member 22, and a washer 24, all accommodated in the main body housing 2.

The handle housing 3 extends downward from the main body housing 2. An electric cord 31 and a trigger 33 are provided at the handle housing 3. Further, a control unit 32 is accommodated in the handle housing 3. An electric power from a commercial power supply is supplied to the motor 4 and the control unit 32 through the electric cord 31. Note that, in place of the electric cord 31, a battery pack may be provided for supplying the electric power to the motor 4 and the control unit 32. The control unit 32 is configured to control a rotation speed of the motor 4 by adjusting an amount of the electric power supplied to the motor 4 in accordance with an operational amount of the trigger 33.

The gear mechanism 5 is a deceleration mechanism configured of a planetary gear mechanism. More specifically, the gear mechanism 5 is configured to reduce the rotation speed of the motor 4 to transmit a rotational drive force from the motor 4 to the hammer 6 via the spindle 23. Note that the gear mechanism 5 is not limited to the planetary gear mechanism and not necessarily provided with the deceleration mechanism.

The spindle 23 is configured to rotate in a rotating direction upon transmission of the rotational drive force from the motor 4 via the gear mechanism 5. As shown in FIGS. 1, 2A and 7, the spindle 23 has a generally disk-shaped flange portion 23A, and a cylindrical portion 23B extending forward from the flange portion 23A. The flange portion 23A and the cylindrical portion 23B are coaxial with each other. In other words, the spindle 23 has an axis extending in a front-rear direction (axial direction).

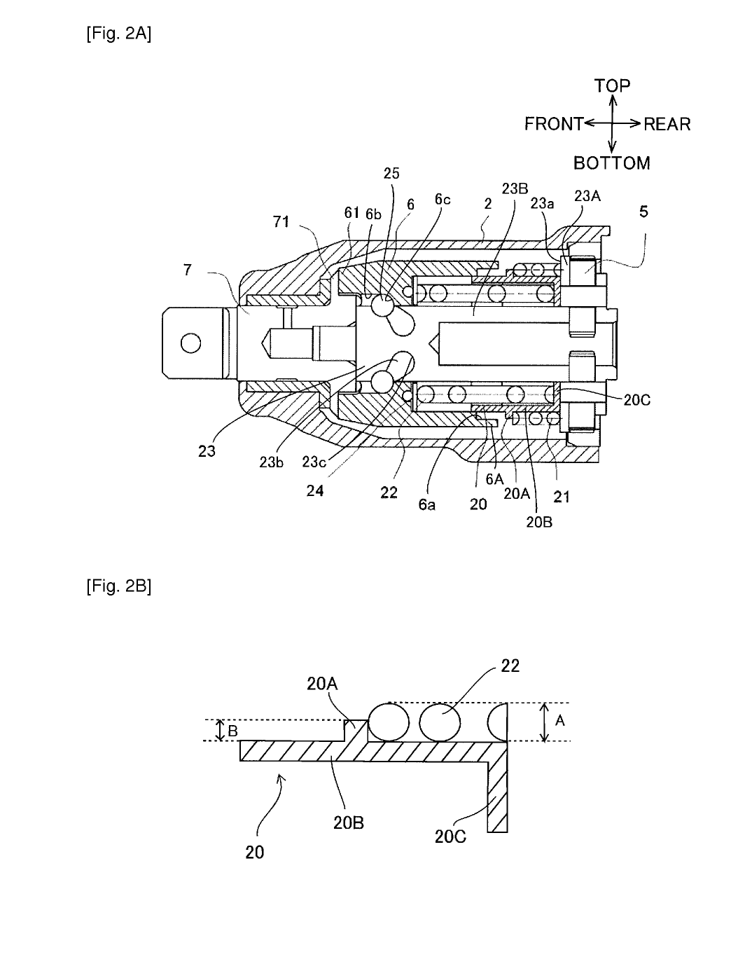

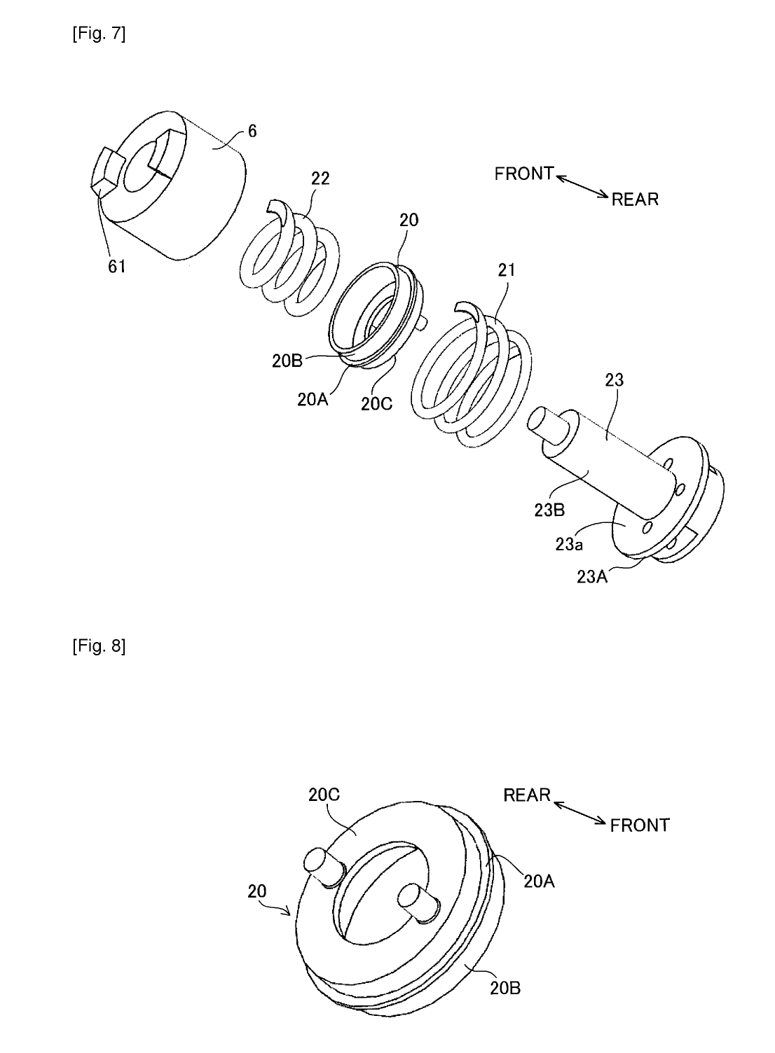

The flange portion 23A is adapted to support planetary gears of the gear mechanism 5. As shown in FIGS. 2A and 7, the flange portion 23A has a front surface 23a. As shown in FIGS. 1 and 2A, the cylindrical portion 23B has an outer circumferential surface formed with a pair of cam grooves 23b. The cam groove 23b has a generally V-shape. Each cam groove 23b has cam ends 23c, 23c at its rear end.

The guide portion 20 is supported to the spindle 23 and configured to guide the axial movement of the hammer 6.

The first resilient member 22 is formed of a compression coil spring, for example, and disposed so as to surround the cylindrical portion 23B of the spindle 23. The first resilient member 22 is configured to urge the hammer 6 forward.

The hammer 6 is supported to the spindle 23 via a cam mechanism (described later) and movable relative to the spindle 23 both in the axial direction of the spindle 23 and in the rotational direction of the spindle 23.

As shown in FIGS. 2A and 7, the hammer 6 has a generally hollow cylindrical shape extending in the front-rear direction. The cylindrical portion 23B of the spindle 23 extends through the hammer 6. The hammer 6 has an inner circumferential surface formed with a pair of cam grooves 6b at a position corresponding to the pair of cam grooves 23b. Each cam groove 6b has a cam end 6c at its rear end. Each cam groove 6b is adapted to hold a steel ball 25 in cooperation with the corresponding cam groove 23b of the spindle 23. The rotational force of the spindle 23 is transmitted to the hammer 6 via the steel balls 25, 25. A pair of a set of the cam groove 6b, the cam groove 23b and the steel ball 25 constitutes the cam mechanism.

Further, the hammer 6 has a front end provided with two hammer projections 61, while the anvil 7 has a rear end provided with two anvil projections 71. The hammer 6 is normally urged forward by the first resilient member 22 so that the hammer projections 61 collide against (hit) the anvil projections 71, respectively, in the rotational direction when the hammer 6 rotates. The collision of the hammer projections 61 against the anvil projections 71 generates a rotational impact force and transmits the rotational impact force to the anvil 7. That is, the anvil 7 is configured to transmit the rotational impact force from the hammer 6 to an end bit.

The hammer 6 is further configured to move backward against an urging force of the first resilient member 22. After the hammer projections 61 have collided against the anvil projections 71, the hammer 6 moves backward against the urging force of the first resilient member 22 while rotating. When the hammer 6 moves backward while rotating, the hammer projections 61 move past the anvil projections 71, respectively, in the rotational direction, and a resilient energy stored in the first resilient member 22 is released to move the hammer 6 forward. Then, again, the hammer projections 61 collide against the respective anvil projections 71, and the hammer 6 moves backward. In this manner, the impact mechanism repeats the above-described impact operation.

Next, an essential portion of the impact wrench 1 will be described while referring to FIGS. 2A to 8.

As shown in FIGS. 2A and 7, the impact wrench 1 further includes a second resilient member 21. The second resilient member 21 is formed of a compression coil spring, for example. The second resilient member 21 is provided at a position radially outward of the first resilient member 22 and seated upon the front surface 23a of the flange portion 23A of the spindle 23. The second resilient member 21 is configured to abut on the hammer 6 when the hammer 6 moves backward.

Providing the second resilient member 21 at a position radially outward of the first resilient member 22 allows the spindle 23 to have a large outer diameter, since the second resilient member 21 needs not be disposed between the spindle 23 and the first resilient member 22. The spindle 23 can be formed to have a large outer diameter and the second resilient member 21 can mitigate an impacting force caused by the backward movement of the hammer 6, thereby minimizing the impact exerted on the cam mechanism, in particular, on the cam grooves 23b formed in the spindle 23. Hence, the service life of the impact wrench 1 can be prolonged.

Further, the second resilient member 21 can relatively gently absorb the impacting force caused by the backward movement of the hammer 6. Accordingly, reduction of noises and vibrations caused by collision of the steel balls 25, 25 against the cam ends 23c, 23c during the impact operation can be realized.

As shown in FIGS. 2A, and 7, the guide portion 20 is supported to the spindle 23. The guide portion 20 is formed in a generally cylindrical shape having a seat portion 20C and a cylindrical portion 20B, as shown in FIGS. 7 and 8.

The seat portion 20C is disposed at a rear end of the guide portion 20 and formed with an opening through which the cylindrical portion 23B of the spindle 23 extends. The cylindrical portion 23B of the spindle 23 is inserted into the opening of the seat portion 20C, so that the guide portion 20 is supported with respect to the spindle 23. Further, the first resilient member 22 is seated upon the seat portion 20C, thereby urging the guide portion 20 rearward toward the flange portion 23A of the spindle 23.

The cylindrical portion 20B is provided so as to surround the first resilient member 22. That is, the cylindrical portion 20B of the guide portion 20 is disposed radially outward of the first resilient member 22.

The cylindrical portion 20B is provided with a projecting portion 20A projecting radially outward from the cylindrical portion 20B along a circumferential direction of the guide portion 20. The projecting portion 20A may include a plurality of projections formed intermittently across an entire outer circumference of the cylindrical portion 20B along the circumferential direction. The projecting portion 20A may be formed partially on the outer circumference of the cylindrical portion 20B along the circumferential direction. The projecting portion 20A is adapted to restrict the second resilient member 21 from moving in the axial direction.

The second resilient member 21 is subjected to positioning at a fixed position in the main body housing 2 by means of the projecting portion 20A. Accordingly, this configuration can maintain the second resilient member 21 at the fixed position and also prevents the second resilient member 21 from being removed from the guide portion 20 and from being displaced from the fixed position. Hence, damages to the second resilient member 21 can be avoided.

The hammer 6 has a rear end provided with an end portion 6A formed with a recess 6a, as shown in FIG. 2A. The recess 6a prevents interference between the rear end of the hammer 6 and the projecting portion 20A when the hammer 6 moves backward.

With this configuration, the second resilient member 21 is subjected to positioning at the fixed position in the main body housing 2, which prevents the second resilient member 21 from being displaced from the fixed position and being removed from the guide portion 20, thereby preventing damages to the second resilient member 21. In addition, since the end portion 6A of the hammer 6 is abuttable on the second resilient member 21 when the hammer 6 moves backward, the second resilient member 21 can relatively gently absorb the impacting force caused by the backward movement of the hammer 6. Accordingly, noises and vibrations caused by collision of the steel balls 25, against the cam ends 23c, 23c during the impact operation can be further reduced.

The second resilient member 21 has a rear edge in contact with the front surface 23a of the flange portion 23A of the spindle 23, as shown in FIG. 2A. Hence, the projecting portion 20A restricts the movement of the second resilient member 21 in the forward direction. Note that, as shown in FIG. 2B, a wire constituting the second resilient member 21 has a diameter A greater than a protruding length B of the projecting portion 20A (i.e. a length of the projecting portion 20A radially outwardly protruding from the cylindrical portion 20B).

As described above, the second resilient member 21 can be maintained at the fixed position by the projecting portion 20A. Hence, the second resilient member 21 can be prevented from being displaced from the guide portion 20.

The end portion 6A provided at the rear end of the hammer 6 is abuttable with a part of a front edge of the second resilient member 21 when the hammer 6 moves backward. When the hammer 6 moves backward to a large extent, both the first resilient member 22 and the second resilient member 21 can absorb the impacting force caused by the backward movement of the hammer 6.

With this configuration, as described above, the hammer 6 is brought into abutment with the first resilient member 22 and the second resilient member 21 before the steel balls 25, 25 respectively impinge on the cam ends 23c, 23c of the cam grooves 23b formed in the spindle 23. Hence, the impacting force caused by the backward movement of the hammer 6 can be gently absorbed by the first resilient member 22 and the second resilient member 21. Accordingly, reduction of noises and vibrations caused by collision of the steel balls 25, 25 against the cam ends 23c, 23c during the impact operation can be realized.

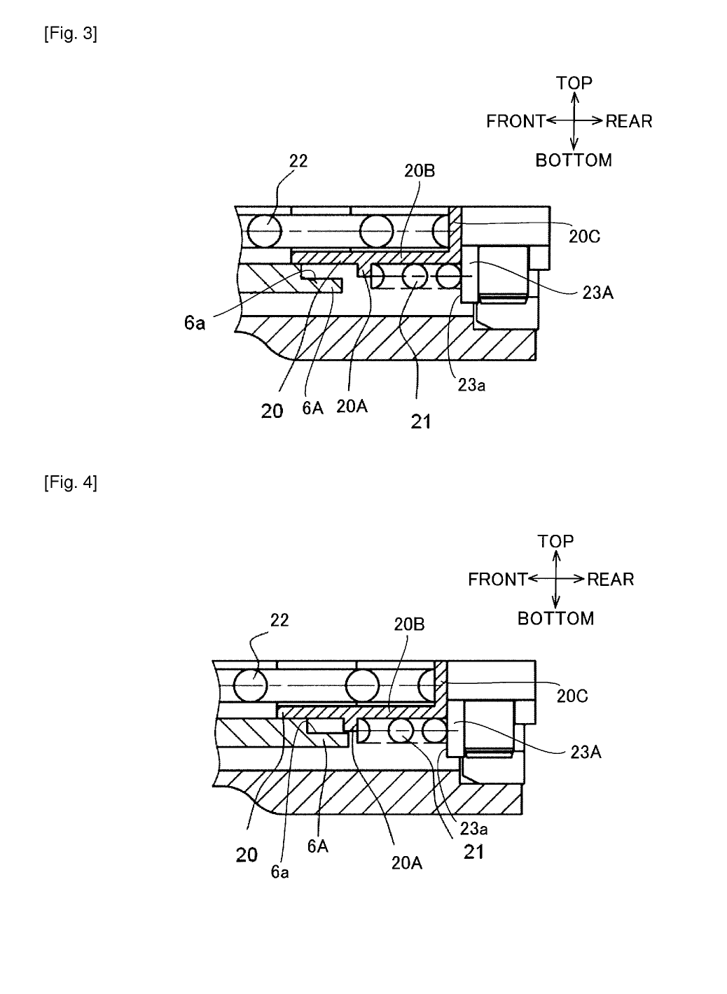

Next, the backward movement of the hammer 6 will be described in detail while referring to FIGS. 3 to 6.

FIG. 3 shows a state prior to separation of each steel ball 25 from the cam end 6c of the cam groove 6b formed in the hammer 6. In the state shown in FIG. 3, the hammer 6 has not yet moved backward. At this time, the second resilient member 21 is in contact with the projecting portion 20A of the guide portion 20 and is spaced apart from the end portion 6A of the hammer 6. The state shown in FIG. 3 will be referred to as a first state.

FIG. 4 shows a state subsequent to the first state. More specifically, FIG. 4 shows a state immediately after each steel ball 25 separates from the cam end 6c of the cam groove 6b (i.e. starts moving toward the cam end 23c of the cam groove 23b) and the hammer 6 (the end portion 6A) starts moving backward. At this time, the second resilient member 21 is in contact with the projecting portion 20A, but is still spaced apart from the end portion 6A. However, compared to the first state, a gap between the second resilient member 21 and the end portion 6A in this state is smaller. The state shown in FIG. 4 will be referred to as a second state.

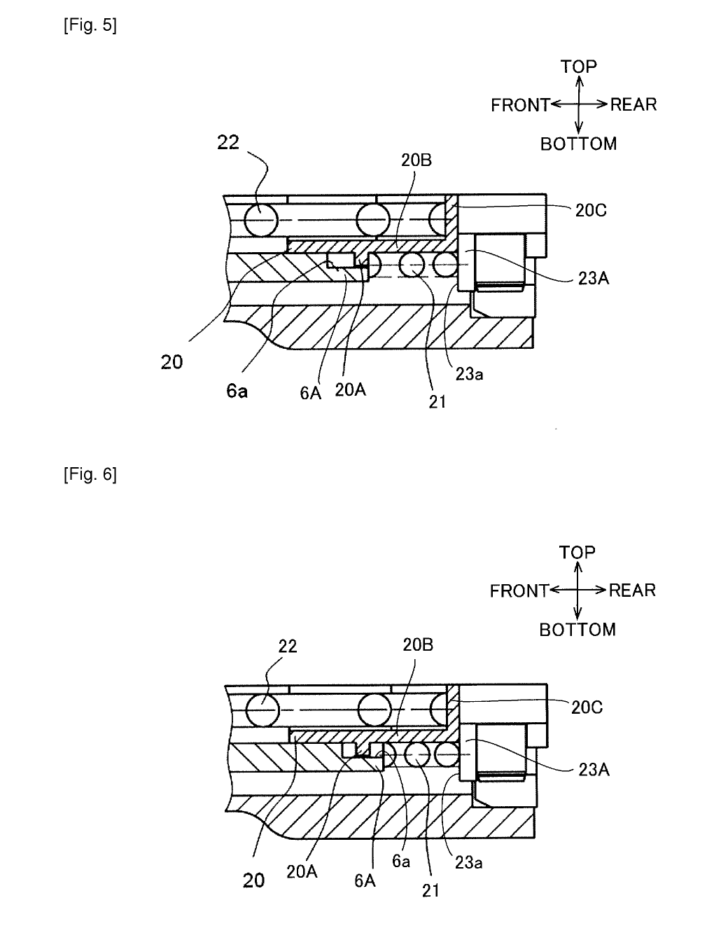

FIG. 5 shows a state subsequent to the second state. More specifically, the state shown in FIG. 5 is at an exact moment when the end portion 6A is brought into abutment with the second resilient member 21, with the hammer 6 moving further rearward from the position shown in FIG. 4. At this time, the front edge of the second resilient member 21 is in contact with both the projecting portion 20A of the guide portion 20 and the end portion 6A of the hammer 6. In this state, the impacting force caused by the backward movement of the hammer 6 is absorbed not only by first resilient member 22 but also by the second resilient member 21. The state shown in FIG. 5 will be referred to as a third state.

FIG. 6 shows a state subsequent to the third state. More specifically, FIG. 6 shows a state when the hammer 6 moves further rearward from the position shown in FIG. 5, and the end portion 6A presses the second resilient member 21 rearward while being in abutment with the second resilient member 21. At this time, the second resilient member 21 is compressed, and not in contact with (i.e. spaced apart from) the projecting portion 20A of the guide portion 20. In this state, the steel balls 25, 25 do not impinge on the cam ends 23c, 23c. The state shown in FIG. 6 will be referred to as a fourth state.

Subsequent to the fourth state, the hammer 6 moves forward to return to the position shown in the first state. Repeating the first to fourth states can prevent each steel ball 25 from intermittently impinging on the cam end 23c of the spindle 23. Hence, vibrations continuously transmitted to the main body housing 2 and the handle housing 3 can be mitigated.

While the present invention has been described in detail with reference to the embodiment thereof, it would be apparent to those skilled in the art that various changes and modifications may be made therein without departing from the spirit of the present invention.

### INDUSTRIAL APPLICABILITY

The rotational impact tool of the present invention can be used for fastening a screw, a bolt, a nut, and the like, to a workpiece.

### REFERENCE SIGNS LIST

1: impact wrench, 2: main body housing, 3: handle housing, 4: motor, 5: gear mechanism, 6: hammer, 6A: end portion, 6a: recess, 6b: cam groove, 6c: cam end, 7: anvil, 20: guide portion 20A: projecting portion, 20B: cylindrical portion, 20C: seat portion, 21: second resilient member, 22: first resilient member, 23: spindle, 23A: flange portion, 23B: cylindrical portion, 23a: front surface, 23b: cam groove, 23c: cam end, 24: washer, 25: steel ball, 31: electric cord, 32: control unit, 33: trigger, 61: hammer projections, 71: anvil projections

1. A rotational impact tool comprising:
a motor configured to generate a rotational drive force;
a spindle configured to rotate in a rotating direction upon transmission of the rotational drive force from the motor, the spindle having an axis extending in an axial direction, the axial direction including a first direction and a second direction opposite to the first direction;
a hammer configured to move in the rotational direction and in the axial direction relative to the spindle to generate a rotational impact force;
a first resilient member configured to urge the hammer in the first direction;
an anvil configured to transmit the rotational impact force from the hammer to an end bit; and
a second resilient member disposed at a position radially outward of the first resilient member, the second resilient member being configured to abut the hammer when the hammer moves in the second direction.

2. The rotational impact tool as claimed in claim 1, wherein the second resilient member comprises a compression coil spring.

3. The rotational impact tool as claimed in claim 1, further comprising a guide portion configured to guide the axial movement of the hammer, the guide portion being configured to be supported to the spindle, the guide portion including a cylindrical portion surrounding the first resilient member and a projecting portion projecting radially outward from the cylindrical portion, the projecting portion being configured to restrict the second resilient member from moving in the axial direction.

4. The rotational impact tool as claimed in claim 3, wherein the hammer includes an end portion formed with a recess, the recess being configured to prevent interference between the end portion and the projecting portion when the hammer moves in the second direction.

5. The rotational impact tool as claimed in claim 3, wherein the cylindrical portion has an outer circumference defining a circumferential direction,
wherein the projecting portion includes a plurality of projections formed intermittently on the outer circumference of the cylindrical portion along the circumferential direction.

6. The rotational impact tool as claimed in claim 3, wherein the cylindrical portion is disposed between the first resilient member and the second resilient member.
